(19) United States
(12) Patent Application Publication
(10) Pub. No.: US 2025/0128591 A1
(43) Pub. Date: Apr. 24, 2025

(54) HYBRID DRIVE SYSTEMS WITH HOUSINGS

(71) Applicant: Superior Diesel, Inc., Rhinelander, WI (US)

(72) Inventors: Timothy C. Stolar, Rhinelander, WI (US); Calvin Conley, Rittman, OH (US)

(73) Assignee: Superior Diesel, Inc., Rhinelander, WI (US)

(21) Appl. No.: 18/925,812

(22) Filed: Oct. 24, 2024

Related U.S. Application Data
(60) Provisional application No. 63/592,721, filed on Oct. 24, 2023.

(51) Int. Cl. B60K 6/405; B60K 11/06

(52) U.S. Cl. CPC B60K 6/405; B60K 11/06

(57) ABSTRACT

A drive system for powering an appliance includes an internal combustion engine, an electric motor, and a housing that couples the electric motor to the internal combustion engine, the housing houses the electric motor and aligns the electric motor with the internal combustion engine along an axis such that the internal combustion engine or the electric motors drives the appliance.

### CROSS-REFERENCE TO RELATED APPLICATION

The present disclosure is based on and claims priority to U.S. Provisional Patent Application No. 63/592,721 filed Oct. 24, 2024, the disclosure of which is incorporated herein by reference.

### FIELD

The present disclosure relates to hybrid drive systems for driving appliances, and specifically to hybrid diesel-electric drive systems for dewatering pumps.

### BACKGROUND

Pumps are commonly used in industrial and commercial applications to remove unwanted water. The pumps are powered by drive systems such as diesel drive systems

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a drive system for powering an appliance includes an internal combustion engine, an electric motor, and a housing that couples the electric motor to the internal combustion engine, the housing houses the electric motor and aligns the electric motor with the internal combustion engine along an axis such that the internal combustion engine or the electric motors drives the appliance.

Optionally, the housing extends between a first housing end and a second housing end and the housing includes a first housing flange at the first housing end that is coupled to the internal combustion engine and a second housing flange at the second housing end configured to couple to the appliance. Optionally, the first housing flange and the second housing flange are each configured to engage with a SAE standard component interface. Optionally, the housing extends between a first housing end and a second housing end and a first cutout at the first housing end receives the internal combustion engine. Optionally, a first housing flange is at the first housing end and the first housing flange is located closer to the second housing end than the first cutout. Optionally, the housing defines a first cavity section in which the internal combustion engine is located and a second cavity section in which the electric motor is received and the first cavity section has an inside housing diameter that is less than another inside housing diameter of the second cavity section. Optionally, the electric motor has a flange that engages with a first projection surface such that the electric motor is aligned with the internal combustion engine. Optionally, the housing includes a first projection that aligns the flange of the electric motor on the first projection surface. Optionally, the housing includes a slot configured to permit heat to dissipate from the electric motor. Optionally, a coupler assembly is configured to couple the appliance to the electric motor.

In certain examples, a housing for coupling an internal combustion engine and an electric motor to an appliance includes a first housing end configured to couple to the internal combustion engine, a second housing end configured to couple to the appliance, and a cavity extending between the first housing end and the second housing end, the cavity is configured to receive the electric motor therein such that the housing aligns the electric motor with the internal combustion engine and the appliance along an axis.

Optionally, the housing defines a cutout configured to receive a portion of the electric motor and thereby align the electric motor with the internal combustion engine. Optionally, a first housing flange is at the first housing end and a second housing flange at the second housing end and each of the first housing flange and the second housing flange are configured to interface with a SAE standard component interface. Optionally, the housing includes a sidewall, a first housing flange that extends outwardly from the sidewall, the first housing flange having a first flange surface, and a lip with a first lip surface, the first flange surface and the first lip surface define a first cutout configured to receive the internal combustion engine. Optionally, the first housing is located closer to the second housing end than the first cutout. Optionally, the housing defines a first cavity section in which the internal combustion engine is located and a second cavity section in which the electric motor is received and the first cavity section has an inside housing diameter that is less than another inside housing diameter of the second cavity section. Optionally, the housing has a first projection surface that is configured to engage the electric motor when the electric motor is aligned with the internal combustion engine. Optionally, the housing includes a sidewall, a first housing flange that extends outwardly from the sidewall, the first housing flange having a first flange surface, and a lip with a first lip surface, the first flange surface and the first lip surface define a first cutout configured to receive the internal combustion engine. Optionally, the housing includes a first projection configured to align the electric motor on the first projection surface. Optionally, the housing includes a slot configured to permit heat to dissipate from the electric motor.

In certain examples, a method for coupling an internal combustion engine and an electric motor to an appliance includes the steps of providing the internal combustion engine with an engine flange, the internal combustion engine including a clutch, coupling a housing to the engine flange such that the housing is fixed relative to the internal combustion engine and the clutch extends into the housing, inserting the electric motor into a cavity defined by the housing and axially moving the electric motor along an axis defined by the housing toward the internal combustion engine, aligning the electric motor along the axis by moving an edge of the electric motor into a cutout defined by the housing, securing the electric motor to the housing, coupling a coupler to the electric motor; and/or securing the appliance to the housing and/or the coupler.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a schematic diagram of an example drive system according to the present disclosure.

FIG. 2 is a perspective view of an example drive system according to the present disclosure coupled to an appliance.

FIG. 3 is a cross-sectional view of the example drive system of FIG. 2.

FIG. 4 is a side view of an example housing according to the present disclosure.

FIG. 5 is a cross-sectional view of the example housing of FIG. 4.

FIG. 6 is a schematic diagram of an example method of coupling an example drive system according to the present disclosure to an appliance.

FIG. 7 includes an exploded view, a partially assembled view, and an assembled view of an example coupler according to the present disclosure.

### DETAILED DESCRIPTION

The present inventors endeavored to develop drive systems that utilize internal combustion engines (e.g., diesel engines) and electric motors together, i.e. hybrid power systems, to power or drive appliances, such as dewatering pumps. Dewatering pumps are exemplarily utilized in industrial, commercial, and/or construction industries to remove water from work areas. Through research and experimentation, the present inventors recognized that it is difficult to couple the engine, the electric motor, and the appliance to each other. Furthermore, the present inventors recognized that the engine, the electric motor, and the appliances may need to be precisely coupled to each other to avoid damage and/or prevent reduced efficiency of the drive system and/or the appliance. Accordingly, the present inventors developed example drive systems and the example housings of the present disclosure, some of which are described hereinbelow

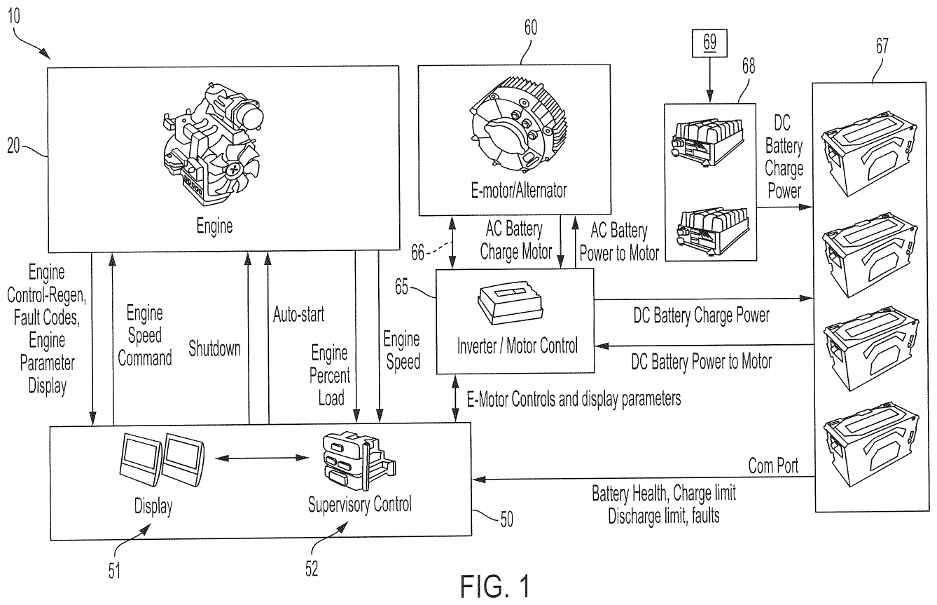

FIG. 1 is a schematic diagram of an example drive system 10 according to the present disclosure. Generally, the drive system 10 includes an engine 20 and an electric motor 60 configured to independently or cooperatively drive or power an appliance 70, such as a pump. The components and other components of the drive system 10 are described in greater detail hereinbelow. Note that while the present disclosure refers to pumps 70 as the example appliance powered or driven by the engine 20 and/or the electric motor 60, the drive system 10 and the components thereof can be utilized to drive or power other mechanical shaft-driven appliances 70, such as woodchippers and industrial vacuums, as well as hydraulically-driven appliances 70, such as core drills, firewood processes, and railway maintenance machinery.

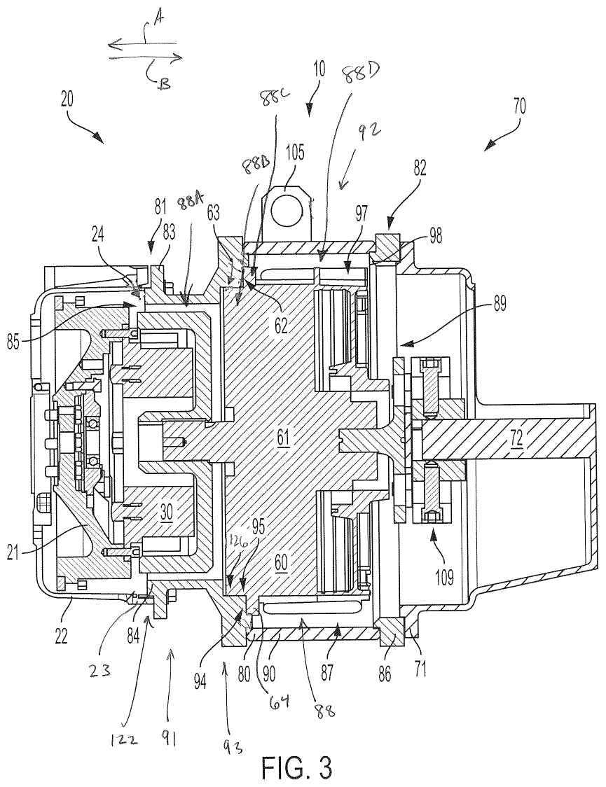

The engine 20 can be any suitable internal combustion engine. In one example, the engine 20 is commercially available from Yanmar (e.g., model 4TINV88C). The engine 20 rotates a flywheel 21 (FIG. 3) and an engine driveshaft (not depicted) which is coupled to the pump 70 (described herein below). In operation, the engine 20 can be operated to rotate the engine driveshaft and thereby power the pump 70.

The engine 20 includes a clutch 30 that is coupled to the electric motor 60 and selectively engaged such that the engine 20 rotates an electric motor driveshaft 61 (“e-motor driveshaft”) of the electric motor 60. In one example, the clutch is a Hilliard clutch. In certain examples, the engine 20 is mounted on a frame or sled (not depicted) which can be easily engaged by a forklift for transporting. Note that in other examples, the clutch 30 is a separate component from the engine 20 that is coupled to both the engine and the electric motor 60,

The electric motor 60 is any suitable electric motor, and in one example, the electric motor 60 is commercially available from Zapi/InMotion (e.g., model Motor/Generator GSM309). The electric motor 60 is preferably designed to fit an SAE #5 flywheel housing interface of the engine 20.

The electric motor 60 is coupled to an inverter/motor control 65 which controls power supplied and received from the electric motor 60. The electric motor 60 and the inverter 65 are configured to send control and/or feedback signals to each other via one or more communication ports 66 to thereby control operation of the electric motor 60. The inverter 65 further facilitates conversion of AC battery charge power from the electric motor 60 to DC battery charge power. The DC battery charger power is routed to a power storage device 67 (described hereinbelow). The inverter 65 also facilitates conversion of DC battery power from the power storage device 67 to AC battery power to the electric motor 60.

The power storage device 67 is any suitable device(s) capable of storing electrical energy. In one example, the power storage device 67 includes one or more battery packs. Example battery packs are commercially available from Vanguard Power (e.g., model 5 kWHr Lithium 80089283 battery pack).

The power storage device 67 can also be charged by a charger, such as a battery charger 68, that receives power from the residential power grid 69. Example battery chargers 68 are commercially available from Vanguard Power (e.g., model Vanguard 1050W Charger). The charger 68 provides power to the power storage device 67 as needed.

The drive system 10 includes a control system 50 that is in communication with the engine 20, the electric motor 60, the inverter 65, and/or the power storage device 67 via one or more wired or wireless communication links. The control system 50 can include a user interface display 51 that receives inputs from the user and/or displays information about the drive system 10 to the user. Example displays are commercially available from Danfoss (e.g., model DM430E). A supervisory microcontroller unit 52 is provided for processing various applications and programs stored on a memory system. Example supervisory microcontroller units 52 are commercially available from Danfoss (e.g., model PLUS+1 microcontrollers). The control system 50 is configured to control the components of the drive system 10. For example, the control system 50 is configured to send engine speed control signals to the engine 20 and shutdown or auto-start the engine 20. The control system 50 receives feedback from the engine such as fault codes, engine percent load, and/or engine speed. The control system 50 receives feedback from the inverter 65 and/or the power storage device 67 such as battery health, charge limits, discharge limits, and/or faults.

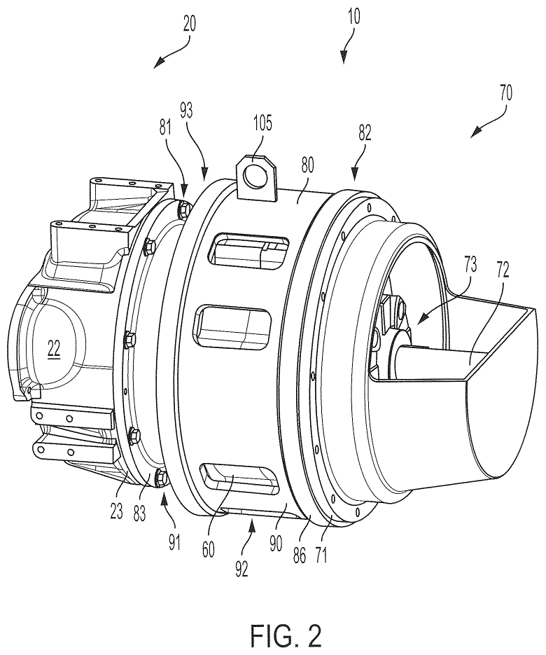

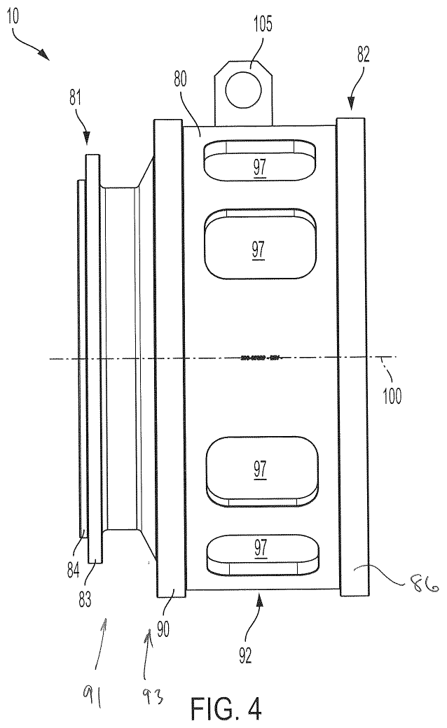

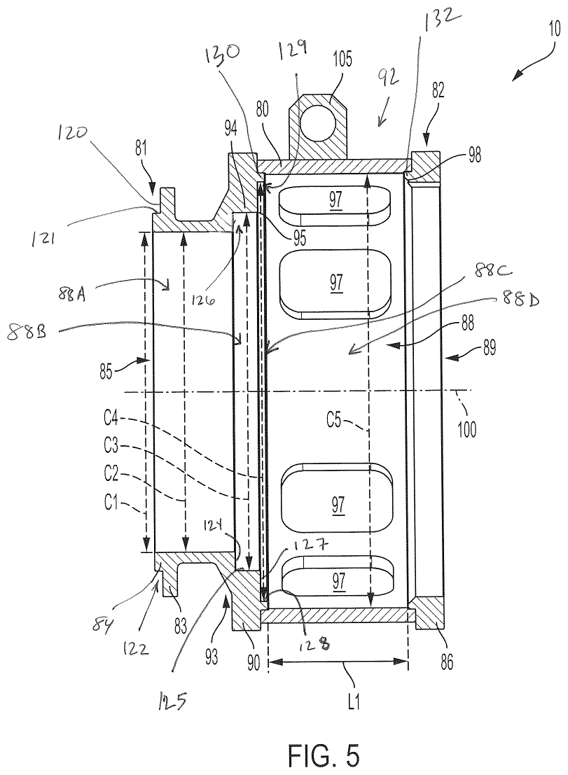

FIGS. 2-3 depict a partial view of the drive system 10 coupled to the pump 70. Specifically, FIGS. 2-3 depict the engine housing 22 of the engine 20 coupled to the pump 70 via a housing 80 (described further herein). The electric motor 60 is housed in the housing 80. FIGS. 4-5 depicts the housing 80 in greater detail, and the housing 80 is configured to facilitate the coupling of the engine 20, the electric motor 60, and the pump 70 to each other.

The engine housing 22 is configured to cover and protect internal components of the engine 20 such as the flywheel 21. The engine 20 further includes a centrifugal clutch 30, such as a Hilliard clutch, which is configured to selectively couple an engine drive shaft (not depicted) to an e-motor driveshaft (not depicted).

The engine housing 22 has a flange 23 orientated or facing in a direction toward the electric motor 60, and the flange 23 facilitates coupling of the engine housing 22 to the housing 80. The housing 80 is secured to the flange 23 with fasteners (e.g., screws, bolts) such that the housing 80 is fixed relative to the engine housing 22.

In certain examples, the flange 23 has a standard SAE flywheel housing interface. In one instance, the flange 23 has a plurality of SAE #5 pilot dimension holes. The engine housing 22 also defines an engine cutout 24 (described in more detail herein).

The housing 80 has a first housing end 81, an opposite second housing end 82, and a housing sidewall 90 extending between the first housing end 81 and the second housing end 82. The housing 80 defines a cavity 88 therein. In certain examples, the housing ends 81, 82 and the housing sidewall 90 are integrally formed with each other. In certain examples, the housing ends 81, 82 and the housing sidewall 90 are cast with each other (e.g., cost with iron or aluminum). In certain examples, the housing ends 81, 82 and the housing sidewall 90 are separate components that are welded together. In certain examples, the housing 80 has a lifting ring 105 attached to the housing sidewall 90 to facilitate the lifting of the housing 80.

The first housing end 81 has a first housing flange 83 that couples to the flange 23 of the engine 20. The first housing end 81 extending in a radially outward direction away from the sidewall 90. The first housing flange 83 has a first flange surface 120 that faces the engine 20 and in a first direction (arrow A). A first lip 84 is also provided at the first housing end 81 and extends in the first direction (arrow A), and the first lip 84 has a first lip surface 121. The first flange surface 120 and the first lip surface 121 define a first cutout 122 in which the engine housing 22 is received (see FIG. 3 which depicts a portion of the engine housing 22 received into the first cutout 122). The first housing flange 83 is located closer to the second housing end 82 than the first cutout 122. In certain examples, the first cutout 122 is generally annular. In certain examples, the first lip 84 is configured to be received into the engine housing 22 (e.g., the first lip 84 seats or nests with a corresponding engine cutout 24 in the engine housing 22). In certain examples, the first flange surface 120 engages with the engine housing 22. The first lip 84, the first housing flange 83, the first flange surface 120, and/or the first lip surface 121 individually or collectively aligns the engine 20 with the housing 80 such that the engine 20 and the housing 80 are precisely and properly positioned relative to each other. The first housing end 81 has a first housing opening 85 with a first inside housing diameter C1. The clutch 30 extends through the first housing opening 85 and into the housing 80.

As noted above, the housing sidewall 90 extends between the housing ends 81, 82. The housing sidewall 90 has a first section 91, a second section 92, and a transition section 93 between the first section 91 and the second section 92. The first section 91 is generally annular and defines a first cavity section 88A of the cavity 88 that has a second inside housing diameter C2 equal to the first inside housing diameter C1. In certain examples, the axial length of the housing sidewall 90 can vary. For instance, a first length DI of the housing sidewall 90 corresponds to the axial length of the electric motor 60 to be located in the cavity 88.

The transition section 93 includes a protrusion or step 94. The step 94 has an edge 95, a first step surface 124, and a second step surface 125. The first step surface 124 faces in a second direction (arrow B) toward the second housing end 82. In certain examples, the first step surface 124 is parallel with the first flange surface 120. The step surfaces 124, 125 define a second cutout 126 in the sidewall 90 in which a portion of the electric motor 60 is received (see FIG. 3). In certain examples, the second cutout 126 is generally annular. In certain examples, the edge 95 is configured to be received into the electric motor 60 (e.g., the edge 95 seats or nests with a corresponding second cutout 126). In certain examples, the first step surface 124 engages with the electric motor 60. The step 94, the step surfaces 124, 125, and/or the second cutout 126 individually or collectively align the electric motor 60 with the housing 80 such that the electric motor 60 and the housing 80 are precisely and properly positioned relative to each other.

The transition section 93 also defines a second cavity section 88B of the cavity 88 that has a third inside housing diameter C3 that is greater than the second inside housing diameter C2, a third cavity section 88C of the cavity 88 that has a fourth inside housing diameter C4 that is greater than the third inside housing diameter C3, and a fourth cavity section 88D of the cavity 88 that has a fifth inside housing diameter C5 that is greater than the fourth inside housing diameter C4.

In certain examples, the drive system 10 is assembled by moving the electric motor 60 in the first direction (arrow A) into the cavity 88 defined by the housing 80. An edge 63 of the electric motor 60 is positioned into the second cutout 126 and the edge 95 of the housing 80 is received into the second cutout 62 of the electric motor 60 (see FIG. 3). As such, that the electric motor 60 is properly located in the housing 80. In certain examples, the electric motor 60 is properly aligned (e.g., center located) ton an axis 100 (FIG. 5) along which the engine driveshaft, the e-motor driveshaft, and the pump driveshaft 72 extend. In these examples, the engine driveshaft, the e-motor driveshaft, and the pump driveshaft 72 are coaxial with each other. Properly locating and aligning the electric motor 60 in the housing 80 aligns the electric motor 60 with the engine 20 and the pump 70 and reduces or eliminates loss of efficiency of the drive system 10 that may be due to misalignment of the electric motor 60 relative to the engine 20 and/or the pump 70. The electric motor 60 is secured to the housing 80 (e.g., the transition section 93) with fasteners (e.g., screws, bolts) such that the electric motor 60 does not rotate relative to the housing 80. In certain examples, the step 94, the second cutout 126, and/or the edge 95 are continuous and each having a generally annular shape.

In certain examples, the electric motor 60 includes a flange 64 that engages with a first projection surface 127 of the housing 80. In these examples, the housing 80 includes a first projection 130 and a second projection surface 128. The first projection 130 aligns the flange 64 of the electric motor 60 with the internal combustion engine 20. The projection surfaces 127, 128 define a third cutout 129 in which the flange 64 is received. The first projection surface 127 is parallel to the first step surface 124 and faces the second housing end 82. The housing 80 can include a second projection 132.

The second housing section 92 has a fifth inside housing diameter C5 that is greater than the fourth inside housing diameter C4. The second section 92 defines one or more slots 97 through which heat dissipates from the electric motor 60 and electrical cables are routed to the electric motor 60. In certain examples, the second housing section 92 has a beveled edge 98. In certain examples, an impeller fan (not depicted) is mounted on one of the engine driveshaft, the e-motor driveshaft, and the pump driveshaft 72 and configured to cool the electric motor 60.

The second housing end 82 has a second housing flange 86 that couples to the mating SAE interface flange 71 of the pump 70. In certain examples, the second housing flange 86 has an SAE #4 standard component interface. The flange 71 of the pump 70 is secured to the second housing flange 86 with fasteners (e.g., screws, bolts) such that the housing 80 is fixed relative to the pump 70. The second housing end 82 also has a second housing opening 89 that is concentric with the first housing opening 85.

Note in certain examples, the first housing flange 83, the first lip 84, the first flange surface 120, the second flange surface 121, the first cutout 122, the second cutout 126, the step surface 124, 125, the third cutout 129, the projections 130, 132, the projection surfaces 127, 128, the step 94, the first step surface 124, the second step surface 125, and/or the edge 95 of the housing 80 can be referred to individually or collectively as an alignment element(s) that are for facilitating proper alignment of the electric motor 60 in the housing 80 and with the engine 20 and/or the pump 70.

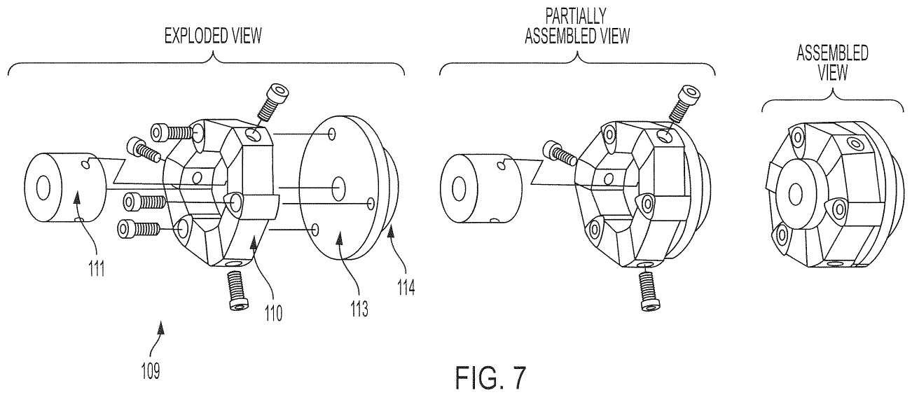

A coupler assembly 109 couples the pump driveshaft 72 to the e-motor driveshaft such that rotation of the e-motor driveshaft drives the pump 70. In certain examples, the coupler assembly 109 comprises elastomeric components to mitigate torsional vibrations. FIG. 7 depicts an example coupler assembly 109 of the present disclosure in more detail. In certain examples, the e-motor driveshaft 61 is coupled to an adaptor shaft 114 and an adaptor plate 113 (an example adapter shaft/plate is commercially available from Superior Diesel, Inc. as part number 210-09028) via a splined shaft placed in a cavity of the e-motor driveshaft 61. The adaptor plate 113 is fastened to the elastomeric coupler 110 (an example elastomeric coupler 110 is commercially available from manufacturer Lovejoy as model number LF50) via axially-oriented threaded fasteners through the adaptor shaft/plate 113, 114. The elastomeric coupler 110 is fixed to a rotating hub 111 (an example rotating hub 111 is commercially Superior Diesel, Inc. as part number 210-09026) via radially oriented threaded fasteners. The rotating hub 111 is coupled to the pump driveshaft 72 (FIG. 3) via a key shaft coupling.

An example operation of the drive system 10 and the pump 70 is described herein below. To power the pump 70 with the engine 20, the engine 20 is activated such that an engine driveshaft (not depicted) is rotated. The clutch 30 is moved to an engaged position such that rotation of the engine drive shaft rotates an e-motor driveshaft 61 of the electric motor 60. The e-motor driveshaft 61 is further coupled to the pump driveshaft 72 via a coupler, such as an elastomeric coupler 110, and thus, rotation of the e-motor driveshaft 61 causes rotation of the pump driveshaft 72. Note that as the engine driveshaft rotates the e-motor driveshaft 61, the electric motor 60 generates AC electrical power which is directed to the inverter 65 and the power storage device 67. The power storage device 67 is recharged with the electrical energy.

To power the pump 70 with the electric motor 60, the clutch 30 is moved to a disengaged position such e-motor driveshaft 61 does not rotate with the engine driveshaft. The control system 50 controls the operation of the electric motor 60 to thereby rotate the e-motor driveshaft 61 and thereby the pump driveshaft 72 independent of the engine 20. Electrical power is provided to the electric motor 60 from the power storage device 67 via the inverter 65.

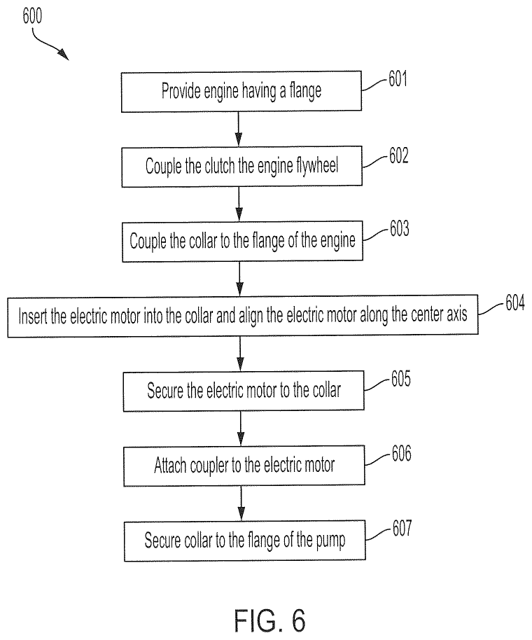

Referring now to FIG. 6, an example method 600 of coupling the drive system 10 to the pump 70 is described hereinbelow. The method begins at step 601 in which the engine 20 with an engine flange 23 is provided. The clutch 30 is coupled to the flywheel 21 via threaded axial fasteners at step 602. The housing 80 is then coupled to the SAE flywheel housing flange 23 of the engine 20, at step 603 (piloted off the SAE housing interface diameter, fixed via axially-oriented threaded fasteners) such that the housing 80 is fixed relative to the engine 20. The clutch extends into the housing 80 and is fastened to the engine driveshaft and the flywheel via axially oriented threaded fasteners. At step 604, the electric motor 60 is inserted via the second housing end 82 into the cavity 88 and axially moved toward the engine 20. The e-motor driveshaft 61 is coupled with the clutch 30 through an external keyed shaft inserted into the mating cavity of the clutch 30. The electric motor 60 is aligned with the center axis 100 defined by the housing 80 by moving the edge 63 of the electric motor 60 into the second cutout 126 defined in the housing 80. As such, the electric motor 60 is centered on the axis 100. The electric motor 60 is then secured to the housing 80 at step 605 with one or more axially oriented threaded fasteners. The elastomeric coupler 110 is attached to the electric motor 60, at step 606, and the second housing end 82 is secured by fasteners to the flange 71 of the pump 70, at step 607. As such, when the second housing end 82 is coupled to the flange 71 of the pump 70, the pump driveshaft 72 aligns with the axis 100 and the electric motor 60 rotates the pump driveshaft 72.

In certain examples, a drive system for powering an appliance includes an internal combustion engine, an electric motor, and a housing that couples the electric motor to the internal combustion engine, the housing houses the electric motor and aligns the electric motor with the internal combustion engine along an axis such that the internal combustion engine or the electric motors drives the appliance.

Optionally, the housing extends between a first housing end and a second housing end and the housing includes a first housing flange at the first housing end that is coupled to the internal combustion engine and a second housing flange at the second housing end configured to couple to the appliance. Optionally, the first housing flange and the second housing flange are each configured to engage with a SAE standard component interface. Optionally, the housing extends between a first housing end and a second housing end and a first cutout at the first housing end receives the internal combustion engine. Optionally, a first housing flange is at the first housing end and the first housing flange is located closer to the second housing end than the first cutout. Optionally, the housing defines a first cavity section in which the internal combustion engine is located and a second cavity section in which the electric motor is received and the first cavity section has an inside housing diameter that is less than another inside housing diameter of the second cavity section. Optionally, the electric motor has a flange that engages with a first projection surface such that the electric motor is aligned with the internal combustion engine. Optionally, the housing includes a first projection that aligns the flange of the electric motor on the first projection surface. Optionally, the housing includes a slot configured to permit heat to dissipate from the electric motor. Optionally, a coupler assembly is configured to couple the appliance to the electric motor.

In certain examples, a housing for coupling an internal combustion engine and an electric motor to an appliance includes a first housing end configured to couple to the internal combustion engine, a second housing end configured to couple to the appliance, and a cavity extending between the first housing end and the second housing end, the cavity is configured to receive the electric motor therein such that the housing aligns the electric motor with the internal combustion engine and the appliance along an axis.

Optionally, the housing defines a cutout configured to receive a portion of the electric motor and thereby align the electric motor with the internal combustion engine. Optionally, a first housing flange is at the first housing end and a second housing flange at the second housing end and each of the first housing flange and the second housing flange are configured to interface with a SAE standard component interface. Optionally, the housing includes a sidewall, a first housing flange that extends outwardly from the sidewall, the first housing flange having a first flange surface, and a lip with a first lip surface, the first flange surface and the first lip surface define a first cutout configured to receive the internal combustion engine. Optionally, the first housing is located closer to the second housing end than the first cutout. Optionally, the housing defines a first cavity section in which the internal combustion engine is located and a second cavity section in which the electric motor is received and the first cavity section has an inside housing diameter that is less than another inside housing diameter of the second cavity section. Optionally, the housing has a first projection surface that is configured to engage the electric motor when the electric motor is aligned with the internal combustion engine. Optionally, the housing includes a sidewall, a first housing flange that extends outwardly from the sidewall, the first housing flange having a first flange surface, and a lip with a first lip surface, the first flange surface and the first lip surface define a first cutout configured to receive the internal combustion engine. Optionally, the housing includes a first projection configured to align the electric motor on the first projection surface. Optionally, the housing includes a slot configured to permit heat to dissipate from the electric motor.

In certain examples, a method for coupling an internal combustion engine and an electric motor to an appliance includes the steps of providing the internal combustion engine with an engine flange, the internal combustion engine including a clutch, coupling a housing to the engine flange such that the housing is fixed relative to the internal combustion engine and the clutch extends into the housing, inserting the electric motor into a cavity defined by the housing and axially moving the electric motor along an axis defined by the housing toward the internal combustion engine, aligning the electric motor along the axis by moving an edge of the electric motor into a cutout defined by the housing, securing the electric motor to the housing, coupling a coupler to the electric motor; and/or securing the appliance to the housing and/or the coupler.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A drive system for powering an appliance, the drive system comprising:
an internal combustion engine;
an electric motor; and
a housing that couples the electric motor to the internal combustion engine;
wherein the housing houses the electric motor and aligns the electric motor with the internal combustion engine along an axis such that the internal combustion engine or the electric motor drives the appliance.

2. The drive system according to claim 1, wherein the housing extends between a first housing end and a second housing end, and the housing includes:
a first housing flange at the first housing end that is coupled to the internal combustion engine; and
a second housing flange at the second housing end that is configured to couple to the appliance.

3. The drive system according to claim 2, wherein the first housing flange and the second housing flange are each configured to engage with a SAE standard component interface.

4. The drive system according to claim 1, wherein the housing extends between a first housing end and a second housing end, and wherein a first cutout at the first housing end receives the internal combustion engine.

5. The drive system according to claim 4, wherein a first housing flange is at the first housing end and the first housing flange is located closer to the second housing end than the first cutout.

6. The drive system according to claim 1, wherein the housing defines a first cavity section in which the internal combustion engine is located and a second cavity section in which the electric motor is received, wherein the first cavity section has an inside housing diameter that is less than another inside housing diameter of the second cavity section.

7. The drive system according to claim 1, wherein the electric motor has a flange that engages with a first projection surface such that the electric motor is aligned with the internal combustion engine.

8. The drive system according to claim 7, wherein the housing includes a first projection that is configured to align the flange of the electric motor on the first projection surface.

9. The drive system according to claim 1, wherein the housing includes a slot configured to permit heat to dissipate from the electric motor.

10. The drive system according to claim 1, further including a coupler assembly configured to couple the appliance to the electric motor.

11. A housing for coupling an internal combustion engine and an electric motor to an appliance, the housing comprising:
a first housing end configured to couple to the internal combustion engine;
a second housing end configured to couple to the appliance; and
a cavity extending between the first housing end and the second housing end, wherein the cavity is configured to receive the electric motor therein such that the housing aligns the electric motor with the internal combustion engine and the appliance along an axis.

12. The housing according to claim 11, wherein the housing defines a cutout configured to receive a portion of the electric motor and thereby align the electric motor with the internal combustion engine.

13. The housing according to claim 11, further comprising a first housing flange at the first housing end and a second housing flange at the second housing end, and wherein each of the first housing flange and the second housing flange are configured to interface with a SAE standard component interface.

14. The housing according to claim 11, wherein the housing includes;
a sidewall;
a first housing flange that extends outwardly from the sidewall, the first housing flange having a first flange surface; and
a lip with a first lip surface;
wherein the first flange surface and the first lip surface define a first cutout configured to receive the internal combustion engine.

15. The housing according to claim 14, wherein the first housing flange 83 is located closer to the second housing end than the first cutout.

16. The housing according to claim 11, wherein the housing defines a first cavity section in which the internal combustion engine is located and a second cavity section in which the electric motor is received, and wherein the first cavity section has an inside housing diameter that is less than another inside housing diameter of the second cavity section.

17. The housing according to claim 11, wherein the housing has a first projection surface that is configured to engage the electric motor when the electric motor is aligned with the internal combustion engine.

18. The housing according to claim 17, wherein the housing includes;
a sidewall;
a first housing flange that extends outwardly from the sidewall, the first housing flange having a first flange surface; and
a lip with a first lip surface;
wherein the first flange surface and the first lip surface define a first cutout configured to receive the internal combustion engine.

19. The housing according to claim 17, wherein the housing includes a first projection that is configured to align the electric motor on the first projection surface.

20. The housing according to claim 11, wherein the housing includes a slot configured to permit heat to dissipate from the electric motor.
